(19) United States
(12) Patent Application Publication
(10) Pub. No.: US 2021/0379414 A1
(43) Pub. Date: Dec. 9, 2021

(54) ELECTRONIC PERSONNEL ACCOUNTABILITY REPORT (EPAR) INTEGRATION

(71) Applicant: 3M INNOVATIVE PROPERTIES COMPANY, St. Paul, MN (US)

(72) Inventors: Jerome Shanko, Jr., Matthews, NC (US); Jason R. CANNON, Waxhaw, NC (US); William E. PARSON, Indian Trail, NC (US); Wesley M. BARBEE, Oxboro, NC (US); Matthew SHANNON, Salisbury, NC (US); Michael S. SABOLCIK, Matthews, NC (US)

(21) Appl. No.: 17/283,392

(22) PCT Filed: Oct. 7, 2019
(86) PCT No.: PCT/IB2019/058528

§ 371 Date: Apr. 7, 2021

Related U.S. Application Data
(60) Provisional application No. 62/745,168, filed on Oct. 12, 2018.

(51) Int. Cl. A62B 9/00; G08B 27/00; G08B 7/06; G08B 21/02; G08B 25/10; A62B 18/02; A62B 7/04

(52) U.S. Cl. CPC A62B 9/006; G08B 27/001; G08B 7/06; A62B 7/04; G08B 25/10; A62B 18/02; G08B 21/02

(57) ABSTRACT

A system, management device, SCBA and wearable device are provided. In one or more embodiments, a wearable device for use with a self-contained breathing apparatus (SCBA) is provided. The device includes device processing circuitry configured to: determine a wireless personal accountability report (PAR) signal has been received, and transition into an alarm state based on the received wireless PAR signal. The alarm state configured to trigger at least one notification while in the alarm state where the triggering of at least one notification is configured to recur until an indication is received.

### TECHNICAL FIELD

The present invention relates to an electronic system for management of personnel at a site of an incident, and unparticular to the integration of an electronic personnel accountability report (ePAR) process in a self-contained breathing apparatus (SCBA).

### BACKGROUND

Emergency situations can occur in which emergency personnel or first responders are often dispatched to these emergency situations in order to provide assistance. Some of these emergency situations may require specific first responders such as firefighters and/or police personnel due to the nature of the emergency situation. One example of such an emergency situation may include a fire, gas leak, etc.

First responders that respond to one or more of these emergency situations often implement a manual personnel accountability report (PAR) in order to enhance site safety by allowing an incident commander (IC) to at least track and account for first responders operating at the site of the incident or emergency situation. For example, an IC may use two-way radios to call for a PAR which is another way of asking “is everyone ok?” in which responses or a lack of responses help confirm or deny whether one or more first responders are safe.

However, even in a small incident, this PAR mechanism can create excess radio traffic as well as opportunities for responses to be missed. For example, a PAR response may be spoken over, on the radio, by another first responder using the same radio frequency for a different communication. One existing system provides ICs with a software interface for initiating a PAR request and sending a signal to various radios associated with the first responders to audibly request the PAR. In this existing system, each first responder may have a button on the radio that facilitates acknowledgment of the responder's status. This forgoes having to use voice-based responses for such an acknowledgment.

Another existing system provides stand-alone PAR devices that a separate from radios used by first responders. This system allows for an IC to initiate a PAR request using a software interface in which a signal is sent to the separate PAR device. A first responder can press two buttons to generate a response on the PAR device for transmission.

### SUMMARY

Some embodiments advantageously provide an integrated PAR signaling system and method.

According to one aspect of the invention, a wearable device for use with a self-contained breathing apparatus (SCBA) is provided. The device includes device processing circuitry configured to: determine a wireless personal accountability report (PAR) signal has been received, and transition into an alarm state based on the received wireless PAR signal. The alarm state configured to trigger at least one notification while in the alarm state where the triggering of at least one notification is configured to recur until an indication is received.

According to one embodiment of this aspect, the at least one notification includes at least one of an audible notification, visual notification and haptic notification. According to one embodiment of this aspect, the visual notification is configured to be displayed on a heads-up display (HUD) associated with the SCBA. According to one embodiment of this aspect, a time period between the recurrence of the at least one notification is configured to periodically decrease if the indication is not received.

According to one embodiment of this aspect, the indication is based on at least one of: a detected predetermined sound, a detected predetermined mechanical force, and a detected predefined motion of a user of the wearable device. According to one embodiment of this aspect, the device processing circuitry is further configured to cause an acknowledgement signal to be transmitted if the indication is received. According to one embodiment of this aspect, the device processing circuitry is further configured to receive another signal in response to the transmitted acknowledgement signal that is configured to transition the device out of the alarm state.

According to another aspect of the disclosure, a self-contained breathing apparatus (SCBA) is provided. The SCBA includes an air tank, an air regulator in fluid communication with the air tank, a face mask in fluid communication with the air tank and air regulator and a device. The device includes device processing circuitry configured to: measure at least one operational parameter related to at least one of the air regulator, the face mask and the air tank determine a wireless personal accountability report (PAR) signal has been received, and transition into an alarm state based on the received PAR signal. The alarm state configured to trigger at least one notification while in the alarm state where the triggering of at least one notification is configured to recur until an indication is received.

According to one embodiment of this aspect, the at least one notification includes at least one of an audible notification, visual notification and haptic notification. According to one embodiment of this aspect, the visual notification is configured to be displayed on a head-up display (HUD) display associated with the face mask. According to one embodiment of this aspect, a time period between the recurrence of the at least one notification is configured to periodically decrease if the indication is not received.

According to one embodiment of this aspect, the indication is based on at least one of: a detected predetermined sound, a detected predetermined mechanical force, and a detected predefined motion of a user of the SCBA. According to one embodiment of this aspect, the device processing circuitry is further configured to cause an acknowledgement signal to be transmitted if the indication is received. According to one embodiment of this aspect, the device processing circuitry is further configured to receive another signal in response to the transmitted acknowledgement signal that is configured to transition the device out of the alarm state.

According to another aspect of the invention, a system for tracking personnel during an active incident is provided. The system includes a plurality of wearable devices for use with a corresponding plurality of self-contained breathing apparatuses (SCBAs), and a management device in communication with the plurality of wearable devices. The management device includes a management processing circuitry configured to cause broadcast of a wireless personal accountability report (PAR) signal to the plurality of wearable devices. Each of the plurality of wearable devices includes device processing circuitry configured to: determine the wireless PAR signal has been received, and transition into an alarm state based on the received wireless PAR signal. The alarm state configured to trigger at least one notification while in the alarm state where the triggering of the at least one notification is configured to recur until an indication is received.

According to one embodiment of this aspect, the at least one notification includes at least one of an audible notification, visual notification and haptic notification. According to one embodiment of this aspect, the visual notification is configured to be displayed on a head-up display (HUD) display associated with a corresponding one of the plurality of the SCBAs. According to one embodiment of this aspect, a time period between the recurrence of the at least one notification is configured to periodically decrease if the indication is not received.

According to one embodiment of this aspect, the indication is based on at least one of: a detected predetermined sound, a detected predetermined mechanical force, and a detected predefined motion of a user of a corresponding wearable device. According to one embodiment of this aspect, the device processing circuitry of each of the plurality of wearable devices is further configured to cause an acknowledgement signal to be transmitted to the management device if the indication is received. The acknowledgement signal from the one the plurality of wearable devices is configured to cause the management device to transmit another signal to the one of the plurality of wearable devices to transition the one of the plurality of wearable devices out of the alarm state. According to one embodiment of this aspect, the management device further includes a graphical user interface configured to: indicate the state of each of the plurality of wearable devices, and trigger the broadcast of the wireless PAR signal based on a user indication.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a block diagram of a PAR signaling system in accordance with the principles of the invention;

FIG. 2 is another block diagram of the PAR signaling system in accordance with the principles of the invention;

FIG. 3 is a flow diagram of a management process in accordance with the principles of the invention; and

FIG. 4 is a flow diagram of a PAR process in accordance with the principles of the invention.

### DETAILED DESCRIPTION

While existing PAR systems provide some level of accountability of personnel at the site of an incident, these existing PAR systems are not without problems. For example, these PAR systems provide little more than two-way radios where a software interface can trigger a PAR request. There is little to no built-in logic in these systems to account for various situations that may arise at these sites. Further, in these systems, the PAR mechanism is not integrated into a self-contained breathing apparatus (SCBA) used by first responders. This disadvantageously adds to the cost and complexity of the system.

Before describing in detail example embodiments that are in accordance with the disclosure, it is noted that the embodiments reside primarily in combinations of system components and processing steps related to PAR signaling and PAR related processes. Accordingly, components have been represented where appropriate by conventional symbols in drawings, showing only those specific details that are pertinent to understanding the embodiments of the disclosure so as not to obscure the disclosure with details that will be readily apparent to those of ordinary skill in the art having the benefit of the description herein.

As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication. For simplicity and ease of explanation, the invention will be described herein in connection with various embodiments thereof. Those skilled in the art will recognize, however, that the features and advantages of the invention may be implemented in a variety of configurations. It is to be understood, therefore, that the embodiments described herein are presented by way of illustration, not of limitation.

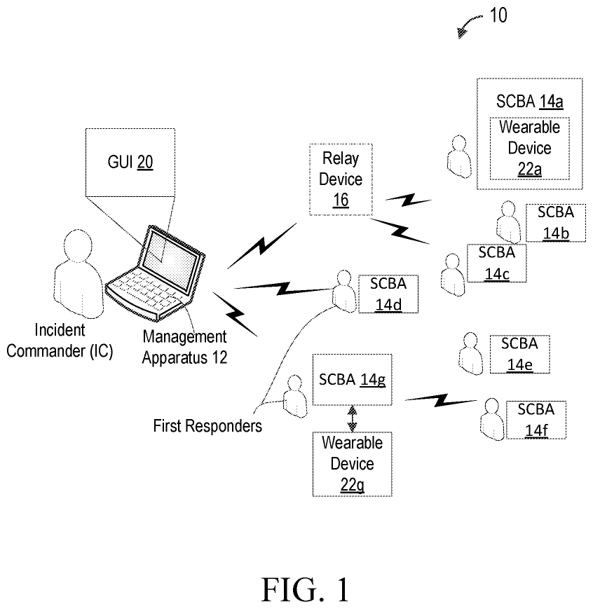

Referring now to drawing figures in which like reference designators refer to like elements there is shown in FIG. 1 is an example system for personnel accountability report (PAR) signaling in accordance with the principles of the invention and designated generally as “10.” System 10 includes one or more management device 12 in communication with one or more self-contained breathing apparatuses (SCBAs) 14a-14g (collectively referred to as SCBA 14) such as via one or more optional relay devices 16 that are configured to relay communications between management device 12 and SCBA 14.

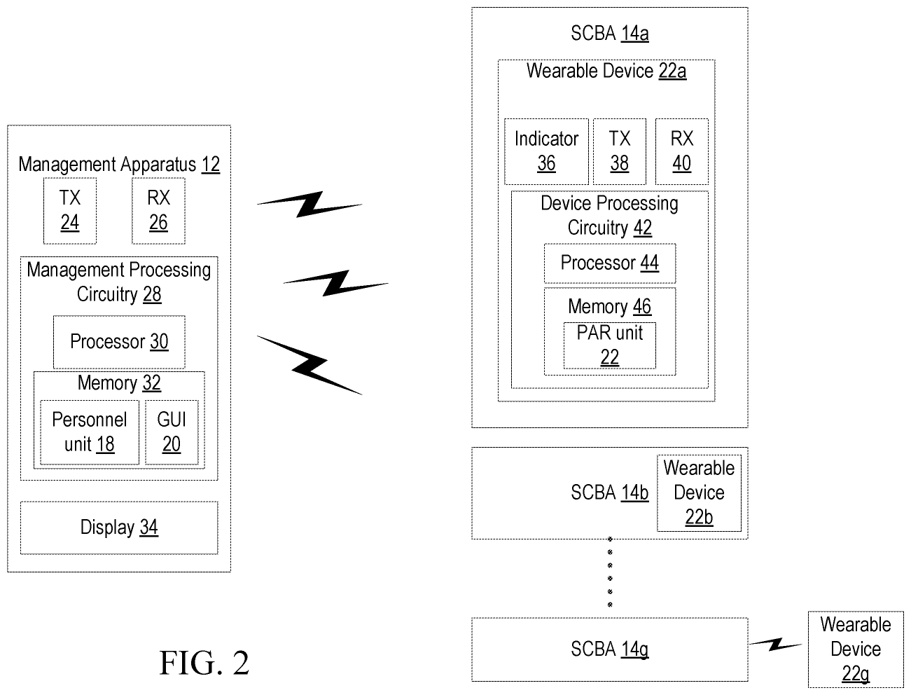

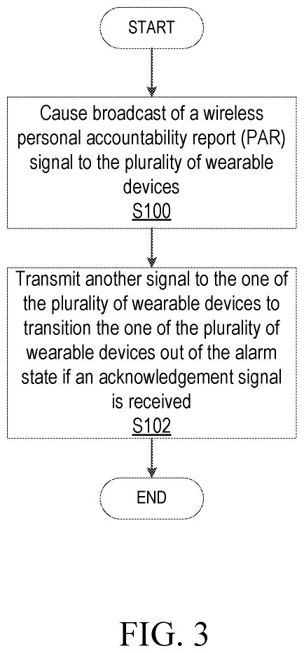

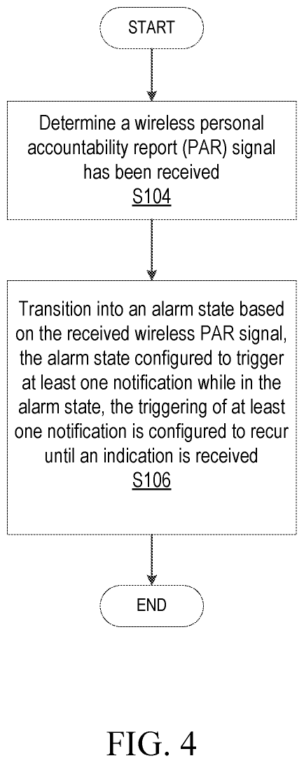

Management device 12 may include personnel unit 18 for performing the personnel process described herein such as with respect to FIG. 3. In one or more embodiments, management device includes a graphical user interface (GUI) for allowing a user such as an incident commander (IC) to track and account for first responders at a site of an incident such a by initiating the personnel process described in FIG. 3. SCBA 14 includes wearable device 22 for performing the PAR process as described in herein with respect to FIG. 4. The PAR process of wearable device 22 is advantageously integrated with SCBA 14 in order to allow for ease of use as compared with existing PAR solutions. In one or more embodiments, the wearable device 22 is removably connected to SCBA 14. The wearable device 22 is described in detail with respect to FIG. 2.

FIG. 2 is a block diagram of system 10 in accordance with the principles of the invention. Management device 12 includes GUI 20 that allows a user such as an incident commander to track and account for first responders at a site of an incident (active incident) such as by initiating the personnel process described with respect to FIG. 3. Management device 12 includes one or more transmitters 24 and one or more receivers 26 for communicating with one or more SCBAs 14. Management device 12 includes management processing circuitry 28. In some embodiments, management processing circuitry 28 may include a processor 30 and memory 32, memory 32 containing instructions which, when executed by processor 30, configure processor 30 to perform the one or more functions described herein such as the process described with respect to FIG. 3. In addition to a traditional processor and memory, management processing circuitry 28 may include integrated circuitry for processing and/or control, e.g., one or more processors and/or processor cores and/or FPGAs (Field Programmable Gate Array) and/or ASICs (Application Specific Integrated Circuitry).

Management processing circuitry 28 may comprise and/or be connected to and/or be configured for accessing (e.g., writing to and/or reading from) memory 32, which may include any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory 32 may be configured to store code executable by circuitry and/or other data, etc. Management processing circuitry 28 may be configured to control any of the methods described herein and/or to cause such methods to be performed, e.g., by processor 30.

Corresponding instructions may be stored in memory 32, which may be readable and/or readably connected to the management processing circuitry 28. In other words, management processing circuitry 28 may include a controller, which may comprise a microprocessor and/or microcontroller and/or FPGA (Field-Programmable Gate Array) device and/or ASIC (Application Specific Integrated Circuit) device. It may be considered that management processing circuitry 28 includes or may be connected or connectable to memory, which may be configured to be accessible for reading and/or writing by the controller and/or management processing circuitry 28. Memory 32 is configured to store personnel unit 18 for performing the personnel process described in detail with respect to FIG. 3. Management device 12 includes one or more displays 34 for displaying GUI 20 (code for which may be stored in memory 32) and/or other information associated with a site of an incident.

SCBA 14 includes wearable device 22 for providing one or more PAR related process as described herein. In particular, wearable device 22 is integrated with SCBA 14. In some embodiments, wearable device 22 includes one or more indicators 36 for indicating information to a user of the SCBA. For example, indicator 36 may provide one or more visual indications, one or audio indications and/or one or more haptic indications to a user. In one or more embodiments, indicator 36 is one or more light emitting elements such as one or more light emitting diodes (LEDs). In one or more embodiments, indicator 36 is a visual graphic on a head-up display (HUD) of SCBA 14 such as a HUD located inside a mask. HUD technology is known and is beyond the scope of this disclosure. In one or more embodiments, indicator 36 is a speaker or audio emitting element for providing audio to the user of SCBA 14 such as, for example, via a speaker or a bone conduction transducer. In one or more embodiments, indicator 36 is a haptic element for providing one or more patterns of haptic feedback to the user of SCBA 14.

Wearable device 22 includes one or more transmitters 38 and one or more receivers 40 for communicating with management device 12 and optionally with one or more other SCBAs 14. Wearable device 22 may be referred to as device 22.

Wearable device 22 includes device processing circuitry 42. In some embodiments, device processing circuitry 42 may include a processor 44 and memory 46, memory 46 containing instructions which, when executed by processor 44, configure processor 44 to perform the one or more functions described herein such as the process described with respect to FIG. 4. In addition to a traditional processor and memory, device processing circuitry 42 may include integrated circuitry for processing and/or control, e.g., one or more processors and/or processor cores and/or FPGAs (Field Programmable Gate Array) and/or ASICs (Application Specific Integrated Circuitry).

Device processing circuitry 42 may comprise and/or be connected to and/or be configured for accessing (e.g., writing to and/or reading from) memory 46, which may include any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory 46 may be configured to store code executable by circuitry and/or other data, etc. Device processing circuitry 42 may be configured to control any of the methods described herein and/or to cause such methods to be performed, e.g., by processor 44.

Corresponding instructions may be stored in memory 46, which may be readable and/or readably connected to the device processing circuitry 42. In other words, device processing circuitry 42 may include a controller, which may comprise a microprocessor and/or microcontroller and/or FPGA (Field-Programmable Gate Array) device and/or ASIC (Application Specific Integrated Circuit) device. It may be considered that device processing circuitry 42 includes or may be connected or connectable to memory, which may be configured to be accessible for reading and/or writing by the controller and/or device processing circuitry 42. Memory 46 is configured to store wearable device 22 for performing the PAR process described in detail with respect to FIG. 4. SCBA 14 includes one or more fluid tanks 48 in fluid communication with one or more fluid regulators 50 and face mask 52 for providing fluid such as air to a user of SCBA 14.

FIG. 3 is a flow diagram of an exemplary personnel process of management device 12 in accordance with the principles of the invention. One or more Blocks described herein may be performed by one or more elements of management device 12 such as by management processing circuitry 28, processor 30, transmitter 24, receiver 26, etc. Management device 12 such as via management processing circuitry 28 and/or transmitter 24 and/or processor 30 is configured to cause (Block S100) broadcast of a wireless personal accountability report (PAR) signal (referred to as “PAR signal”) to the plurality of wearable devices 22. The PAR signal being configured to transition the wearable device 22 into an alarm state where the alarm state is configured to cause the wearable device 22 to trigger at least one notification while in the alarm state. In one or more embodiments, the PAR signal may include a message or data configured to cause the transitioning of the wearable device 22 from one state to another state. In one or more embodiments, the PAR signal is addressed to a subset of wearable devices 22 associated with a subset of SCBAs 14 such as to allows for granularity in which SCBAs 14 are to perform the PAR process.

Management device 12 such as via management processing circuitry 28 and/or transmitter 24 and/or processor 30 is configured to transmit (Block S102) another signal to the one of the plurality of wearable devices 22 to transition the one of the plurality of wearable devices 22 out of the alarm state if an acknowledgment signal is received. For example, an acknowledgment signal may be received from a wearable device 22 that is responding to the PAR signal such that the user associated with the wearable device 22 and SCBA 14 has acknowledged his/her safety or that he/she is “ok”. In one or more embodiments, management device 12 may indicate via GUI 20 and/or display 34 wearable devices 22 from which acknowledgments have or have not been received, among other information based on the PAR process. This provides the incident command or user of management device with accountability of personnel at the site of the incident.

In one or more embodiments, management device 12 is configured to periodically cause broadcast of a PAR signal to one or more wearable devices 22 based on the time when the one or more wearable devices 22 and/or SCBA 14 were activated.

FIG. 4 is a flow diagram of the PAR process at wearable device 22 in accordance with the principles of the invention. One or more Blocks described herein may be performed by one or more elements of wearable device 22 such as by device processing circuitry 42, processor 44, transmitter 38, receiver 40, etc. In one or more embodiments, wearable device 22 is a physical part of SCBA 14 and integrated (e.g., logically integrated) with SCBA 14. In one or more embodiments, wearable device 22 is removably attachable to SCBA 14 and/or user of SCBA 14, where wearable device 22 is integrated with one or more components of SCBA 14 such as with face mask 52. For example, in one or more embodiments, wearable device 22 is in electronic communication with HUD of face mask 52 and may trigger one or more notifications at face mask 52.

Wearable device 22 such as via device processing circuitry 42 and/or receiver 40 and/or processor 44 is configured to determine (Block S104) a wireless personnel report (PAR) signal has been received. For example, the PAR signal may be received from one or more of a management device 12, a relay device and another SCBA 14. In one or more embodiments, the PAR signal is a broadcast PAR signal such that any active SCBA 14 and wearable device 22 receiving the PAR signal may perform the PAR process, i.e., the PAR signal is not addressed to any one specific SCBA 14. In one or more embodiments, the PAR signal is addressed to a specific subset of SCBAs 14/wearable devices 22 such that determining a PAR signal has been received may involve processing the PAR signal to determine the PAR signal is addressed to the wearable device 22 receiving the PAR signal.

Wearable device 22 is configured to transition (Block S106) into an alarm state based on the received wireless PAR signal where the alarm state is configured to trigger at least one notification while in the alarm state. In one or more embodiments, the triggering of at least one notification is configured to recur until an indication is received. For example, the indication may be received from the user as described herein. In one or more embodiments, the wearable device 22 is configured to operate in at least two states such as an alarm state and non-alarm state. In one or more embodiments, the alarm state may correspond to a state where one or more notifications are triggered and may recur until an indication, e.g., from a first responder/user, is received and/or a signal is received from management device 12 indicating to the wearable device 22 to transition out of the alarm state such as to the non-alarm state. Recurrence can be at fixed time intervals or can the intervals can differ, e.g., decreasing as time goes on as noted below.

According to one or more embodiments, the at least one notification includes at least one of an audible notification, visual notification and haptic notification. In one or more embodiments, the haptic notification is provided by a piezo patch that may be attached to the user such as to a user's hip. According to one or more embodiments, the visual notification is configured to be displayed on a head-up display (HUD) of face mask 52 associated with the SCBA 14. According to one or more embodiments, a time period between the recurrence of the at least one notification is configured to periodically decrease if the indication is not received, e.g., indication from a user associated with the wearable device 22 and SCBA 14 is not received. For example, the notification may be triggered at a faster pace if the user of SCBA 14 fails to respond to the PAR signal and/or fails to cause wearable device 22 to transmit an acknowledgment signal to management device 12.

According to one or more embodiments, the indication can be based on at least one of: a detected predetermined sound, a detected predetermined mechanical force, and a detected predefined motion of a user of the wearable device 22. In one or more embodiments, the detected predetermined sound is associated with an audible voice response from a user associated with wearable device 22 and SCBA 14. In one or more embodiments a bone conduction device in communication with wearable device 22 is used to receive the audible voice response from the user. In one or more embodiments the detected predetermined mechanical force is received from a button on a shoulder mounted console on a user.

According to one or more embodiments, the device processing circuitry 42 is further configured to cause an acknowledgement signal to be transmitted if the indication is received. According to one or more embodiments, the device processing circuitry 42 is further configured to receive another signal in response to the transmitted acknowledgement signal that is configured to transition the device out of the alarm state.

In one or more embodiments, wearable device 22 may communicate with management device 12 using Zigbee messaging and/or other low power wireless communication protocols. In one or more embodiments, one or more PAR signals may be associated with one or more priorities such as that lower priority PAR signal may trigger one or more specific notifications at wearable device 22 while a higher priority PAR signal may trigger one or more other different and specific notifications at wearable device 22. In other words, each priority level may be associated with one or more predefined notifications at wearable device 22. In one or more embodiments, the higher priority PAR signal may overwrite a previously received lower priority PAR signal such that notification(s) associated with the higher priority PAR signal may be immediately triggered at wearable device 22 upon determining a higher priority PAR signal has been received. In one or more embodiments, wearable device 22 such as via device processing circuitry 42 and/or processor 44 is configured to measure at least one operational parameter related to at least one of the air regulator, the face mask and the air tank.

As will be appreciated by one of skill in the art, the concepts described herein may be embodied as a method, system 10, management device 12 and wearable device 22. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a non-transitory tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the disclosure is not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wearable device for use with a self-contained breathing apparatus (SCBA), the device comprising:
device processing circuitry configured to:
determine a wireless personal accountability report (PAR) signal has been received; and
transition into an alarm state based on the received wireless PAR signal, the alarm state configured to:
trigger at least one notification while in the alarm state, the triggering of at least one notification being configured to recur until an indication is received.

2. The wearable device of claim 1, wherein the at least one notification includes at least one of an audible notification, visual notification and haptic notification.

3. The wearable device of claim 2, wherein the visual notification is configured to be displayed on a head-up display (HUD) associated with the SCBA.

4. The wearable device of claim 1, wherein a time period between the recurrence of the at least one notification is configured to periodically decrease if the indication is not received.

5. The wearable device of claim 1, wherein the indication is based on at least one of:
a detected predetermined sound;
a detected predetermined mechanical force; and
a detected predefined motion of a user of the wearable device.

6. The wearable device of claim 1, wherein the device processing circuitry is further configured to cause an acknowledgement signal to be transmitted if the indication is received.

7. The wearable device of claim 6, wherein the device processing circuitry is further configured to receive another signal in response to the transmitted acknowledgement signal that is configured to transition the device out of the alarm state.

8. A self-contained breathing apparatus (SCBA), the SCBA comprising:
an air tank;
an air regulator in fluid communication with the air tank;
a face mask in fluid communication with the air tank and air regulator; and
a device including device processing circuitry configured to:
measure at least one operational parameter related to at least one of the air regulator, the face mask and the air tank;
determine a wireless personal accountability report (PAR) signal has been received; and
transition into an alarm state based on the received PAR signal, the alarm state configured to:
trigger at least one notification while in the alarm state, the triggering of at least one notification being configured to recur until an indication is received.

9. The SCBA of claim 8, wherein the at least one notification includes at least one of an audible notification, visual notification and haptic notification.

10. The SCBA of claim 9, wherein the visual notification is configured to be displayed on a head-up display (HUD) display associated with the face mask.

11. The SCBA of claim 8, wherein a time period between the recurrence of the at least one notification is configured to periodically decrease if the indication is not received.

12. The SCBA of claim 8, wherein the indication is based on at least one of:
a detected predetermined sound;
a detected predetermined mechanical force; and
a detected predefined motion of a user of the SCBA.

13. The SCBA of claim 8, wherein the device processing circuitry is further configured to cause an acknowledgement signal to be transmitted if the indication is received.

14. The SCBA of claim 13, wherein the device processing circuitry is further configured to receive another signal in response to the transmitted acknowledgement signal that is configured to transition the device out of the alarm state.

15. A system for tracking personnel during an active incident, the system comprising:
a plurality of wearable devices for use with a corresponding plurality of self-contained breathing apparatuses (SCBAs); and
a management device in communication with the plurality of wearable devices, the management device including:
a management processing circuitry configured to cause broadcast of a wireless personal accountability report (PAR) signal to the plurality of wearable devices; and
each of the plurality of wearable devices including:
device processing circuitry configured to:
determine the wireless PAR signal has been received;
transition into an alarm state based on the received wireless PAR signal, the alarm state configured to:
trigger at least one notification while in the alarm state, the triggering of the at least one notification being configured to recur until an indication is received.

16. The system of claim 15, wherein the at least one notification includes at least one of an audible notification, visual notification and haptic notification.

17. The system of claim 16, wherein the visual notification is configured to be displayed on a head-up display (HUD) display associated with a corresponding one of the plurality of the SCBAs.

18. The system of claim 15, wherein a time period between the recurrence of the at least one notification is configured to periodically decrease if the indication is not received.

19. The system of claim 15, wherein the indication is based on at least one of:
a detected predetermined sound;
a detected predetermined mechanical force; and
a detected predefined motion of a user of a corresponding wearable device.

20. The system of claim 15, wherein the device processing circuitry of each of the plurality of wearable devices is further configured to cause an acknowledgement signal to be transmitted to the management device if the indication is received; and
the acknowledgement signal from the one the plurality of wearable devices configured to cause the management device to transmit another signal to the one of the plurality of wearable devices to transition the one of the plurality of wearable devices out of the alarm state.

21. (canceled)
